(19) United States
(12) Patent Application Publication
(10) Pub. No.: US 2007/0290007 A1
(43) Pub. Date: Dec. 20, 2007

(54) Cap with an angled spray channel for an aerosol container or a spray container

(75) Inventor: Heiko Eberhardt, Oberursel (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company, Cincinnati, OH (US)

(21) Appl. No.: 11/807,547

(22) Filed: May 29, 2007

Related U.S. Application Data
(63) Continuation of application No. PCT/EP2005/012435, filed on Nov. 21, 2005.

(30) Foreign Application Priority Data
Nov. 30, 2004 (EP) 102004057702.1

(51) Int. Cl. B65D 83/00; B05B 1/30

(52) U.S. Cl. 222/402.13; 239/577

(57) ABSTRACT

In order to achieve a comfortable level of spray noise using a cap having a button and an angled spray channel, it is suggested that the spray channel be manufactured in one piece from elastic plastic, e.g., from TPE or TPU.

### FIELD OF INVENTION

The invention involves a cap with a spray angle integrated into the cap, which surrounds an angled spray channel, and with a button to activate a valve of a container, particularly an aerosol container or spray container. The button is intended to act on the stem of the container via the angled spray channel to cause the stem to turn outward upon manual activation of the button, and to cause the valve to open, whereby the product contained in the container, e.g., hairspray, can exit via the stem and via a product discharge opening on the cap for this purpose, while passing through the spray channel. The spray channel has an acoustic seal to achieve a comfortable noise level during the spraying action.

### BACKGROUND

This type of cap is already known. The spray channel of this cap is surrounded by sound-absorbing material to reduce the noise level, but also to provide particularly strong dampening of individual frequency ranges. There are layers consisting of TPE (thermoplastic elastomer) or TPU (thermoplastic polyurethane) provided for this purpose around the spray channel.

The known cap has the disadvantage that the layered manufacturing of the spray angle is relatively expensive.

Thus, the present invention provides a solution for this disadvantage. This is achieved in that the spray channel is manufactured in one piece from an elastic plastic.

### SUMMARY OF THE INVENTION

The suggested cap has the advantage that it is relatively economical because it is manufactured in one piece. The high level of elasticity of the material used dampens the vibrations in the material, which can cause noise towards the exterior.

The design of the known spray angle causes relatively high levels of noise emission because relatively hard materials are used, e.g., PP (Polypropylene) for the spray angle. These embodiments, also known as spray levers, are designed to be very stable mechanically. They can transfer large forces, which, however, do not occur in actual use.

The suggested spray channel can also transfer the required forces to the stem. In addition, it is capable of transferring the path differences of a button, which can be swiveled around a joint, with the differences being about up to 7 mm at the end of the button, to the valve, which normally has a trigger path of from about 3.5 mm to about 4 mm. The operational force is not necessarily increased in this process.

The spray channel can be manufactured from a very flexible, elastic, and soft material, particularly a plastic from the TPE or TPU families. One single type of plastic is sufficient for the spray channel. The spray channel can, however, also be manufactured from a mixture of at least two plastics from the TPE or TPU families, particularly PP or PE (Polyethylene). Mixtures of TPE with PP or PE or another plastic are also conceivable. Tests have shown that a spray lever consisting of PP must contain at least about 40% TPE to have a good noise dampening effect.

### DETAILED DESCRIPTION

The present invention is explained below in more detail using two figures that show an example of the embodiment. The following is shown:

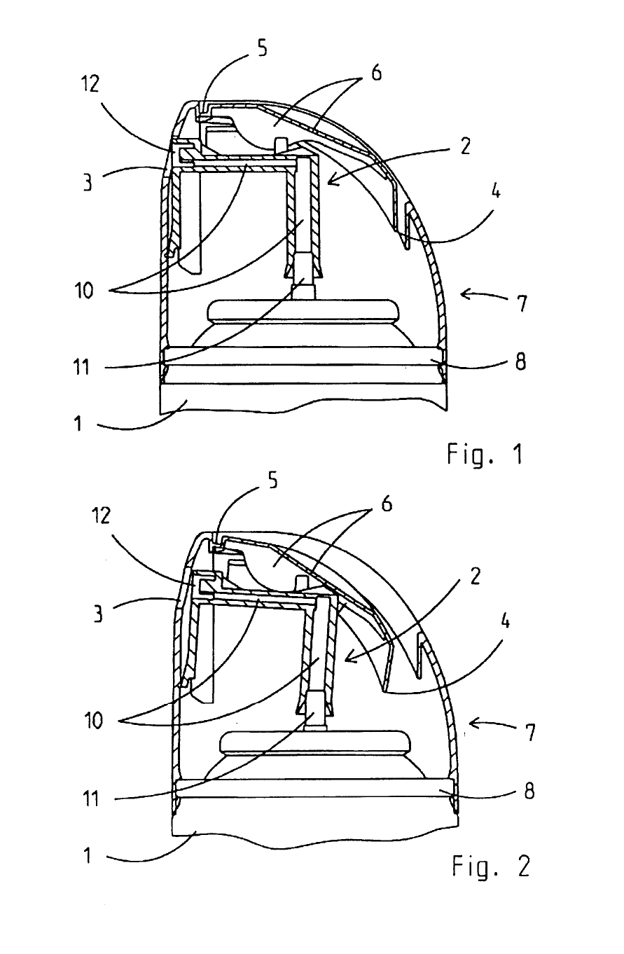

FIG. 1, in a side view with a partial vertical section, shows a cap with a button, which acts on a spray lever containing an angled spray channel, wherein the cap is placed on a container containing hair spray, and wherein the button is not activated; and

FIG. 2, in a side view with partial vertical section, shows the object of FIG. 1, but with the button activated.

For a cap 7 with a spray angle 2 (integrated into the cap 7), which surrounds an angled spray channel 10, a button 6 is used to activate a valve of a container 1, which is an aerosol container. The button is used to swivel around a joint 5 and to act on a stem 11 of the container 1 via the angled spray channel 10, to cause the stem 11 to turn outwards upon activation of the button 6, and also to cause the valve (not shown) to open, whereby the product contained in the container 1 can exit via the stem 11 and via a product discharge opening 3 intended for this purpose on the cap 7, while passing through the spray channel 10. The spray channel 10 has an acoustic seal. To that end, the spray channel is manufactured in one piece from an elastic plastic. It consists of about 50% PP and about 50% TPE. The TPE is Santoprene®. However, it can also be Vayram® or Evoprene®. Activation of the button 6 causes the spray channel 10 to be deformed because it is connected to the cap 7 in the area of the product discharge opening 3. The spray noise is relatively pleasant.

Container

1 Container

2 Spray angle

3 Product discharge opening

4 End of button

5 Joint

6 Button

7 Cap

8 Edge

10 Spray channel

11 Stem

12 Nozzle

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cap with a spray angle integrated into the cap, which surrounds an angled spray channel, and with a button to activate a valve of a container, wherein the button is intended, via the angled spray channel, to act on a stem of the container, to cause the stem to turn outwards upon a manual activation of the button, and to cause the valve to open, whereby the product contained in the container can exit via the stem and via a product discharge opening, while passing through the spray channel, and wherein the spray channel has an acoustic seal, wherein the spray channel is manufactured from elastic plastic in one piece.

2. A cap according to claim 1, wherein the spray channel is manufactured from a very flexible, elastic, and soft material, particularly a plastic from the TPE or TPU families.

3. A cap according to claim 1, wherein the spray channel is manufactured from a mixture of at least two plastics of the TPE and TPU families.

4. A cap according to claim 3, wherein the mixture comprises a TPE.

5. A cap according to claim 4, wherein the spray channel comprises PP and at least about 40% wt. TPE.

6. A cap according to claim 4, wherein said mixture comprises polypropylene or polyethylene.
